(19) United States
(12) Patent Application Publication
(10) Pub. No.: US 2010/0103060 A1
(43) Pub. Date: Apr. 29, 2010

(54) FLAT PANEL ANTENNA, SUCH AS FOR USE IN A CELLULAR TELEPHONE SITE OF A WIRELESS TELECOMMUNICATIONS SYSTEM

(76) Inventor: Chad Au, Kirkland, WA (US)

Correspondence Address: PERKINS COIE LLP;PATENT-SEA, P.O. BOX 1247, SEATTLE, WA, 98111-1247, US

(21) Appl. No.: 12/367,486

(22) Filed: Feb. 6, 2009

Related U.S. Application Data
(60) Provisional application No. 61/107,958, filed on Oct. 23, 2008.

(51) Int. Cl. H01Q 21/00; H01Q 3/12; H01Q 3/36; H01Q 1/12; H01Q 1/48

(52) U.S. Cl. 343/720; 343/757; 343/878; 343/848

(57) ABSTRACT

An antenna described herein includes a supporting substrate configured to be secured without requiring mounting holes, and a conductive antenna ground plane formed at the supporting substrate. A set of spaced apart and independently operable antenna elements are formed at the supporting substrate and are sized to wirelessly exchange communications signals at a first predetermined frequency or first predetermined range of frequencies for wireless communications. The spaced apart antenna elements are configured for electronic beam steering of the antenna, for remote electronic tilting of the antenna, for operating the antenna as a phased array, etc.

### CROSS-REFERENCE TO RELATED APPLICATION

This application claims the benefit of the assignee's U.S. Provisional Patent Application No. 61/107,958, filed Oct. 23, 2008 (attorney docket number 31419-8087.US00).

### BACKGROUND

In urban environments, antennas for cell sites are often located on buildings. These antennas, however, can be aesthetically unappealing. As a result, building owners or management organizations may require that antennas be covered with screens or other barriers that degrade their performance, have the antennas located in undesirable locations that reduce their performance, and so forth. Furthermore, such antennas must often be mounted to buildings by means of anchors or holes drilled in the building, but landlords often prohibit or severely restrict any damage to their buildings.

The need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description

### BRIEF DESCRIPTION OF THE DRAWINGS

FIG. 1 is a schematic diagram illustrating an example of a planar or flat cellular antenna on a building, with an enlargement of that antenna.

FIG. 2 is a block diagram illustrating components of a base station employing the antenna of FIG. 1.

FIG. 3A is a cross-sectional view of a portion of the antenna of FIG. 1.

FIG. 3B is a top isometric view of a portion of the antenna of FIG. 1.

FIG. 3C is a front isometric view of an alternative to the antenna of FIG. 3B.

FIGS. 4A and 4B are schematic diagrams illustrating implementation of the antenna of FIG. 1 as a phased array.

FIGS. 5A and 5B are front and rear views, respectively, of the antenna of FIG. 1, showing an example of an attachment system.

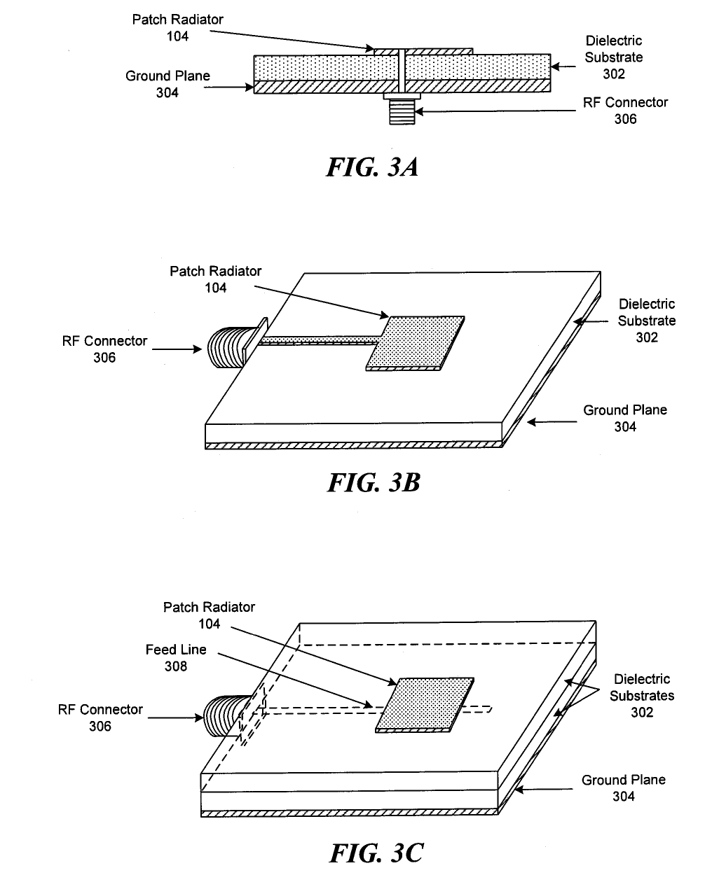

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 304 is first introduced and discussed with respect to FIG. 3).

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

Described in detail below is an adapting antenna that may be mounted as a generally flat or planar antenna on an exterior of a building or other surface, where the antenna includes an array of antenna elements that may be electrically directed using, for example, phased array or remote electrical tilt technologies. The antenna may be secured to an upper portion of a building using adhesives, without the need for drilling holes into the building, and painted to camouflage or blend into the building to be aesthetically pleasing.

One suitable location where the inventive antenna may be used is a water tower. Existing antennas require holes to be made into a mounting surface so that anchor bolts can be forced into such holes to secure the antenna. Instead, the inventive antenna described herein may be affixed to an upper portion of a water tower using only adhesives, where it would be impracticable to drill into the water tower.

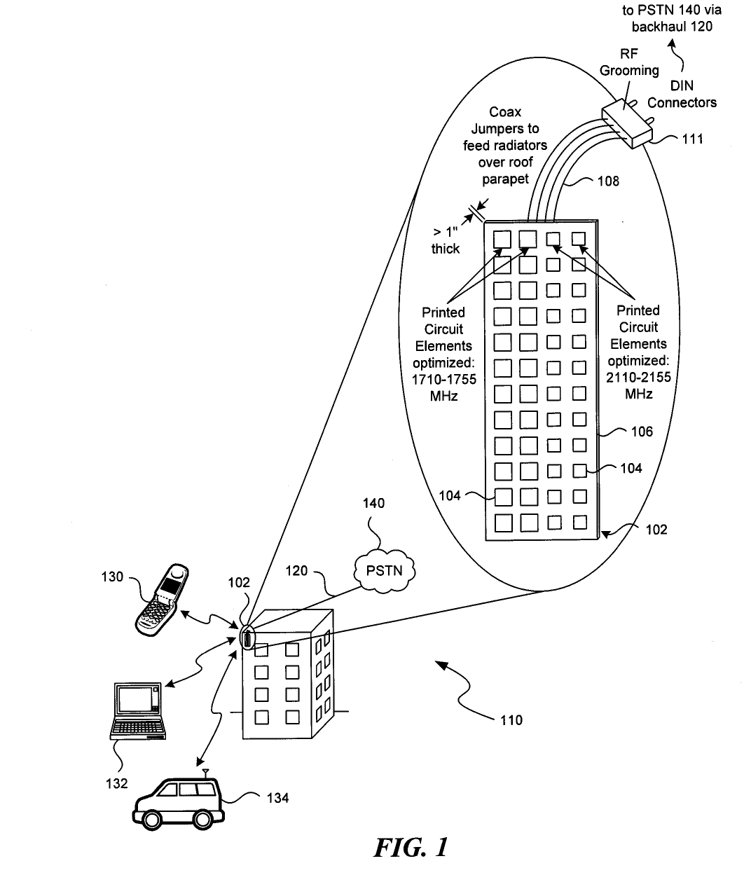

Referring to FIG. 1, an example of a flat or planar cellular antenna 102 is shown. The antenna includes patch antenna portions 104 formed as multiple islands of a conducting material such as copper. The patch antennas 104 may be formed as flat conductive shapes deposited on a dielectric panel or substrate 106, which may be formed from a Teflon and fiberglass composite material having a thickness of one-quarter to one-eighth inch. As shown in FIG. 1, two different sized square patch antennas 104 may be employed, such as a first set optimized for 1710-1755 MHz, and a second set optimized for 2110-2155 MHz, although other patch antennas may be added too, such as those optimized for 1900 MHz (PCS). While AWS and PCS frequency bands are mentioned, the antenna may be optimized for other bands such as DCS, 850 MHz and 700 MHz.

A corporate feed connects the patch antennas 104 to one or more feed lines or leads 108. The leads 108 may couple to an RF grooming module 111, and then to DIN connectors and on to other radio transceiver components (not shown in FIG. 1). The RF grooming module 111 may include a duplexer to split transmit and receive signals, and to assist in distributing signals to the antenna elements. The RF grooming module may also include a low noise amplifier and/or electrical tilting components to assist in downward, horizontal and/or azimuth tilt or steering of antenna signals.

The antenna 102 may be placed at the exterior, upper portion of a building and secured using adhesives, thereby avoiding drilling or putting anchors into the building. The thin profile allows the antenna not to protrude far from the building, and it can be painted to match the exterior of the building, thereby camouflaging the antenna. The antenna may be sized to provide a desired radiation pattern, gain, resonant frequency, impedance and other parameters for the selected communication frequency or bandwidth. In one example, the antenna is approximately six feet high, four to five feet wide, and less than an inch thick. While only one antenna is shown on the building, two or more antennas may be placed on each side of the building to provide for enhanced coverage.

The antenna 102 may form part of a cell site 110, that permits mobile devices 130, 132 and 134 to communicate with a public switched telephone network (PSTN) 140, or with other networks (not shown), such as a data network to thereby access content servers. As shown, cell site 110 is configured to wirelessly communicate with mobile devices 130, 132, and 134 via antenna 102 and to communicate with PSTN 140 and data network via backhaul 120. While FIG. 1 illustrates one example of a suitable environment in which the invention may be practiced, various modifications such as inclusion of additional devices, consolidation and/or deletion of various devices, and shifting of functionality from one device to another device may be made without deviating from the invention.

Cell site 110 may include virtually any device for facilitating wireless network access. For example, cell site 110 may be a wireless telephony base station, a wireless network access base station, a wireless email base station, and/or the like. As an example, cell site 110 may be operated by a mobile telephony service provider. Generally, cell site 110 is configured to facilitate wireless network access for mobile devices 130, 132, and 134 by providing an interface (via antenna 102) between mobile devices 130, 132, and 134 and backhaul 120. Cell site 110 and mobile devices 130, 132, and 134 may communicate using any wireless protocol or standard. These include, for example, Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Multiple-input/Multiple-output (MIMO) protocols, and/or the like.

Mobile devices 130, 132, and 134 may include virtually any devices for communicating over a wireless network, PSTN 140, and/or data network. Such devices include cellular telephones, GSM telephones, TDMA telephones, UMTS telephones, EVDO telephones, LTE telephones, Personal Digital Assistants (PDAs), radio frequency (RF) devices, infrared (IR) devices, handheld computers, laptop computers, wearable computers, tablet computers, pagers, integrated devices combining one or more of the preceding devices, and/or the like. As such, mobile devices 130, 132, and 134 range widely in terms of capabilities and features. For example, a cellular telephone may have audio input/output components, a numeric keypad and the capability to display only a few lines of text. However, other cellular telephones (e.g., smart phones) may have a touch-sensitive screen, a stylus, full keyboard and/or a relatively high-resolution display.

PSTN 140 is configured to provide interconnectivity between mobile devices 130, 132, and 134 and other telecommunications devices. For example, PSTN 140 may be employed to provide circuit-switched audio communications between various telecommunications devices. However, in other systems, PSTN 140 may include Voice Over Internet Protocol (VOIP) networks, private telecommunications networks, and/or the like. Also, PSTN 140 may include devices such as 5ESS switches, Private Branch Exchange (PBX) switches, base station controllers, and/or the like.

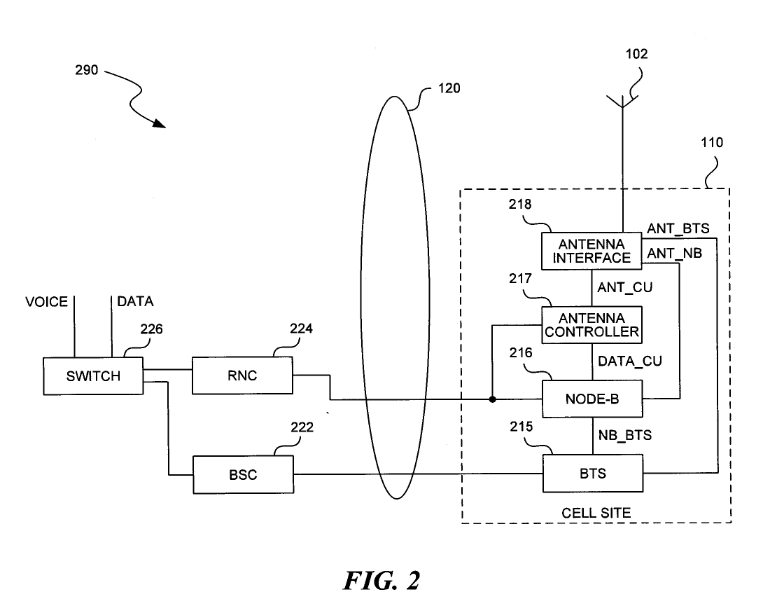

FIG. 2 is a block diagram of communications system 290. Communications system 290 includes cell site 110, base station controller (BSC) 222, radio network controller (RNC) 224, and switch 226. Cell site 110 includes base station (BTS) 215, Node-B 216, antenna controller unit 217, and antenna interface 218. While communications system 290 is illustrated as a GSM/UMTS communications system, the invention is not limited to GSM/UMTS communications systems. Any suitable communications system may employ all or part of the invention.

BSC 222 may be coupled between switch 226 and cell site 110 to control certain operational aspects of BTS 215. For example, BSC 222 may be configured to control handoffs, network registration for mobile devices, channel allocation, radio transmitter output power, and/or the like. BSC 222 may be employed to control any number of base stations.

RNC 224 may be coupled between switch 226 and cell site 110 to control certain operational aspects of Node-B 216 of cell site 110. Also, RNC 224 may be employed to control any number of Node-Bs. As an example, RNC 224 may be a UMTS counterpart of BSC 222. In addition, RNC 224 may also include a content gateway to access content servers over a data network.

Switch 226 is configured to provide voice and data interfaces, respectively, to BSC 222 and RNC 224. For example, switch 226 may be configured to switch voice traffic from one or more base station controllers to a PTSN or to a telephone switch such as a 5ESS switch, a PBX switch, and/or the like via signal VOICE. Likewise, switch 226 may be further configured to switch data from one or more RNCs to a data network, to a router, to another switch, and/or the like via signal DATA. Also, switch 226 may include a mobile switching center (MSC), a media gateway, a call gateway, and/or the like.

Switch 226 may also be coupled to an operations and maintenance center (OMC) that is configured to provide a centralized platform from which a wireless communications service provider may monitor and control operational aspects of the elements of communications system 290, including operation of the antenna 102. Further, switch 226 may also include or further operate as a content gateway.

As stated above, cell site 110 may include BTS 215, Node-B 216, antenna controller unit 217, and antenna interface 218. In typical communications systems, BTS 215 and Node-B 216 are configured to provide a low-level radio interface to mobile devices under the control of BSC 222 and RNC 224. For example, BTS 215 may provide low-level GSM radio interfacing while Node-B 216 provides low-level UMTS radio interfacing. Also, cell site 110 may include limited command and control functionality or no command and control functionality. Instead, BSC 222 and/or RNC 224 may provide such functionality while cell site 110 merely provides a physical layer interface to associated mobile devices.

Cell site 110 may also include antenna interface 218 to interface BTS 215, and Node-B 216, to antenna(s) 102. Antenna interface 218 may also include a smart bias tee that is configured to physically interface the RF signals among of BTS 215, Node-B 216, and one or more antennas 102. A smart bias tee may be further adapted to provide power to receiver preamplifiers in antenna(s) 102.

In other examples, antenna interface 218 may include duplexers, diplexers, multiplexers, and/or the like. Also, antenna interface 218 may be omitted in certain cell sites. For example, BTS 215 may be configured to receive RF signals from Node-B 216 and couple these and other RF signals to antenna(s) 102.

The antenna 102 can be vertically polarized, or have dual polarization, which can help with, for example, filtering unwanted RF interference in received signals. Moreover, with the assistance of the antenna controller unit 217 located at the cell site 110, or located remotely, the antenna 102 may be electronically directed or controlled. For example, using known remote electrical tilt (RET) technology, subtle changes in phase to each of the patch antennas 104 can be applied by the control unit 217 to orient the antenna radiation pattern vertically (typically downward). RET technology is included in the 3GPP luant interface standard, and thus the antenna controller 217 interacts with beam steering of the antenna 102 through the luant interface (see 3GPP standards 3GPP TS 25.461 V8.0.0 (2007-09), 3GPP TS 25.462 V7.4.0 (2007-09), and 3GPP TS 25.466 V8.1.0 (2007-12), which describe physical, signaling, and application aspects).

Similar techniques can be employed to provide azimuth or horizontal steering of the antenna. Moreover, phased array techniques further help with beamforming and antenna directionality to provide desired RF radiation patterns. Beamforming takes advantage of interference to change the directionality of the array. When transmitting, a beamformer (control unit 217) controls the phase and relative amplitude of the signal at each transmitter (each patch antenna 104), in order to create a pattern of constructive and destructive interference in the wavefront. When receiving, information from different patch antennas 104 is combined in such a way that the expected pattern of radiation is preferentially observed.

The antenna 102 may be configured to operate as an antenna array. An antenna array consists of multiple active antennas coupled to a common source or load to produce a directive radiation pattern. Spatial relationship of the patch antennas may also contribute to the directivity of the antenna 102. Use of the term “active antennas” is intended to describe elements whose energy output is modified due to the presence of a source of energy in the element (other than the mere signal energy which passes through the circuit) or an element in which the energy output from a source of energy is controlled by the signal input. The antenna 102, together with the antenna controller unit 217, may allow the cell site 110 to operate as a phased array.

A phased array is a group of antennas (patch antennas 104) in which the relative phases of the respective signals feeding the antennas are varied in such a way that the effective radiation pattern of the array is reinforced in a desired direction and suppressed in undesired directions. The relative amplitudes of—and constructive and destructive interference effects among—the signals radiated by the individual antennas determine the effective radiation pattern of the array. A phased array may be used to point a fixed radiation pattern. Phased arrays increase the antenna's gain, magnifying the emitted RF energy toward the horizon, which in turn greatly increases the cell site's broadcast range. In these situations, the distance to each element from the transmitter is identical, or is one (or other integer) wavelength apart. Phasing the antenna array such that the lower elements are slightly delayed (by making the distance to them longer) causes a downward beam tilt, which is useful if the antenna is quite high on a building.

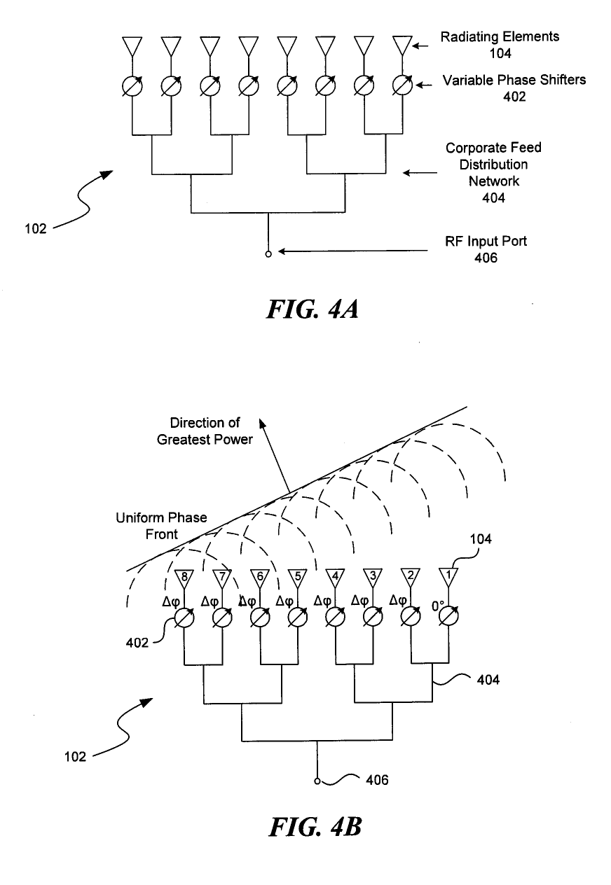

FIGS. 4A and 4B show an example of the antenna 104 operating as a phased array. As shown, each of the multiple radiating elements or patch antennas 104 are connected to variable phase shifters 402. The phase shifters are in turn coupled to an RF input port 406 via a corporate feed distribution network 404. As shown more clearly in FIG. 4B, when radiating element number 1 radiates at zero degrees phase, with each successive element radiating at an additional (often small) difference in phase, the antenna 102 can provide a uniform phase front in a direction of greatest power toward a desired location. The desired location may be, for example, directed downward at a highway, where the antenna 102 is positioned at the top of a building facing the highway. The changes in phase may be adjusted electronically, and remotely, so as to control the antenna and provide appropriate adjustment of its radiation pattern. For example, the antenna controller 217 may receive external control signals to control the variable phase shifters 402. While the radiation pattern for the antenna 102 may be initially adjusted and then set and no longer adjusted, the antenna could be adjusted for various reasons, such as for power conservation. Details on adjusting antenna tilt or beam forming to conserve power may be found in the assignee's U.S. patent application Ser. No. 12/170,696, filed 10 Jul. 2008, entitled “Cell Site Power Conservation.” The system described herein may employ and be compatible with existing electrical antenna tilt technologies and standards, such as the 3GPP luant interface noted above.

FIGS. 3A-3C show examples of construction of the antenna 102. The illustration of FIGS. 3A-3C represent only a portion of the antenna 102, and are of a more schematic nature: actual manufacture or implementation of the antenna 102 based on the detailed description provided herein may vary widely, depending upon the application, building or structure on which the antenna is located, bandwidth/frequency range or telecommunications needs of the telecommunications provider, and so forth. As shown in FIG. 3A, the patch radiator or antenna 104 is formed on an upper surface of a dielectric substrate 302, which in turn is formed over a ground plane 304. The ground plane may be a conductive sheet, such as of aluminum or copper, where the dielectric substrate 302 may be of any appropriate dielectric material, such as Teflon-glass, plastic, glass, fiberglass, etc. An RF connector 306, forming an RF input port, connects to both the ground plane 304 and to the patch antenna 104.

As shown in FIG. 3B, the patch antenna 104 may be coupled to the RF connector 306 by means of a trace, conductive strip or feed line 308. The ground plane 304 can be connected likewise to another portion of the RF connecter 306. Alternatively, as shown in FIG. 3C, two dielectric substrates 302 may be provided, with the feed line 308 sandwiched therebetween. In this alternative, the patch antenna 104 is capacitively coupled to the feed line 308. Of course, many other actual implementations may be envisioned for generating such a planar antenna. Examples of other planar antennas may be found in European Patent No. 1788664A1, U.S. Pat. Nos. 5,086,304, 5,936,579, 6,633,257, and in L. Zyga, “Goodbye, Bunny Ears: Future Antennas May be Flat”, physorg.com, Apr. 24, 2008.

Overall, the substrate 302 of the antenna 104 can be fabricated out of a number of commercially available circuit board and RF-friendly materials. The substrate 302 can be secured to any mounting surface including but not limited to concrete panels, steel sheets, glass, etc. Specific dimensions of the various antenna components are determined by the desired performance and frequency band for which it is to operate, e.g. a need for more antenna gain would result in a larger aperture, an array tuned for PCS would be slightly smaller than one tuned for AWS, etc. Further, the antenna may have a hydrophobic finish so that moisture would be shed from its face so as to prevent detuning. If the antenna was not environmentally protected, it may be composed of UV stable materials and be weather-resistant.

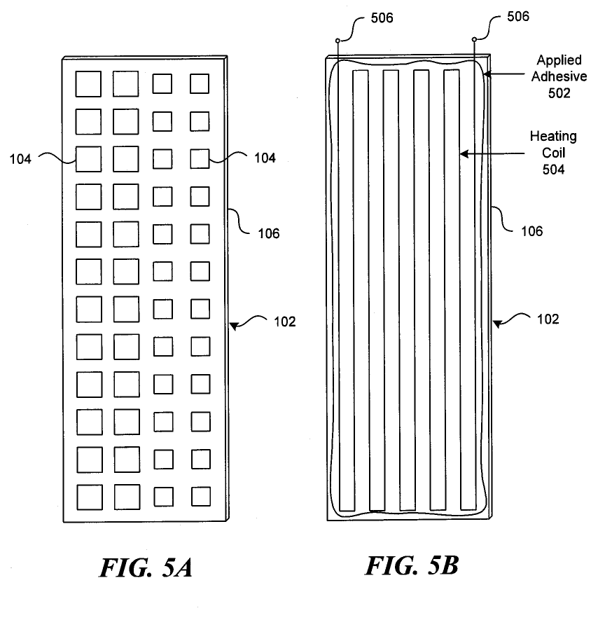

Referring to FIGS. 5A and 5B, an example of an optional method for removably mounting the antenna 102 to an exterior of a building is shown. Here, an adhesive 502 is applied to an underside of the antenna, to affix the antenna to an exterior of a building without employing anchors or requiring the need to drill holes into the building. The adhesive may be selected to soften when heat is applied to it, so that the antenna may be removably secured to the building. As shown in FIG. 5B, a heating element or coil 504 is positioned on an underside of the substrate 106, over which the adhesive 502 is applied. Then, if a sufficiently high current is applied to terminals 506, the adhesive softens, thereby allowing the antenna to be removed from the building in a non-destructive way. Thus, while the antenna could be secured to a mounting surface using traditional mechanical anchors that require holes to be formed into the surface, this alternative embodiment using adhesives avoids the need for such holes.

While the antenna is described herein for use on buildings, it likewise may be applied to any surface. Indeed, the antenna may be secured to the interior or exterior of a user's home in, for example, a picocell or femtocell wireless communications environment.

A picocell may be communicatively coupled to a base station in the cellular network. The picocell is a wireless access point typically covering a relatively small area, such as within a building (e.g., office, shopping mall, train station, or the like) or within an aircraft, ship, train or other vehicle. A picocell may, for example, be analogous to a WiFi access point, except that it typically broadcasts using the licensed spectrum of an associated wireless carrier. The picocell serves as an access point for routing communication between the mobile devices and the network, network device, etc. One or more picocells may be coupled to the BSC by way of wired or wireless connection. It will be appreciated by those skilled in the relevant art that picocell implementations of the invention are within the scope of aspects of the invention disclosed herein.

Alternatively or additionally, the antenna may be used in a data network, such as an IP-based network, and take the form of a VoIP broadcast architecture, UMA or GAN (Generic Access Network) broadcast architecture, or a femtocell broadcast architecture. Voice Over Internet Protocol, or VoIP, is a telecommunication system for the transmission of voice over the Internet or other packet-switched networks. Unlicensed Mobile Access or UMA, is the commercial name of the 3GPP Generic Access Network or GAN standard. Somewhat like VoIP, UMA/GAN is a telecommunication system which extends services, voice, data, and IP Multimedia Subsystem/Session Initiation Protocol (IMS/SIP) applications over IP-based networks. For example, a common application of UMA/GAN is in a dual-mode handset service in which device users can seamlessly roam and handover between local area networks and wide area networks using a GSM/Wi-Fi dual-mode mobile phone. UMA/GAN enables the convergence of mobile, fixed and Internet telephony, sometimes called Fixed Mobile Convergence. Femtocells are much like picocells, broadcasting within the licensed spectrum of a wireless telecommunications carrier. Femtocells are typically designed for use in residential or small business environments. Femtocells connects to the service provider's network much like UMA/GAN access points, namely over IP-based networks. Overall, the antenna 102 may be used in femtocell, picocell, and/or access points, on any of various buildings, vehicles, or other locations, to provide the benefits described herein.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the invention provided herein can be applied to other systems, not necessarily the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

I/We claim:

1. An antenna system for facilitating cellular telephone communications, the antenna comprising:
a substantially flat panel, wherein the flat panel has front and rear sides,
wherein the flat panel is sized and configured to be mounted to an upper portion of a building or structure with an adhesive applied to the rear side;
a first set of flat patch antennas formed at a front surface of the flat panel, wherein the first set of patch antennas are formed of a conductive material and are sized to wirelessly exchange communications signals at a predetermined range of lower frequencies;
a second set of flat patch antennas formed at the front surface of the flat panel, wherein the second set of patch antennas are formed of the conductive material and are sized to wirelessly exchange signals at a predetermined range of higher frequencies,
wherein the higher frequencies are higher than the lower frequencies;
wherein the first set of flat patch antennas form a first array of spaced apart radiating antenna elements, and wherein the second set of flat patch antennas form a second array of spaced apart radiating antenna elements;
a ground plane formed at a rear surface of the flat panel, wherein the ground plane is formed of the conductive material;
an output port electronically coupled to the first set of flat patch antennas, to the second set of flat patch antennas, and to the ground plane; and,
an antenna controller electronically coupled to the output port, wherein the antenna controller is configured to, based on a received control signal, electronically steer a first wireless communications beam from the first array of antenna elements and a second wireless communications beam from the second array of antenna elements.

2. The antenna system of claim 1 wherein the first and second sets of flat patch antennas and the ground plane are formed of copper;
wherein the predetermined range of low frequencies is 1710 MHz to 1755 MHz and the predetermined range of high frequencies is 2110 MHz to 2155 MHz;
wherein the first and second arrays of antenna elements are vertically polarized; and
wherein the antenna controller is further configured to provide azimuth steering for wireless signals from the first and second arrays of antenna elements.

3. The antenna system of claim 1, further comprising:
a set of variable phase shifters coupled to at least some of the first and second sets of flat patch antennas, wherein control signals from the antenna controller adjust phase of the phase shifters; and
a corporate feed coupled between the set of phase shifters and the output port.

4. The antenna system of claim 1, further comprising:
a conductive heating element secured at the rear side of the flat panel, wherein the conductive heating element is configured to heat and at least partially melt the adhesive when a current is applied to the conductive heating element to permit removal of the flat panel from the building or structure.

5. An antenna for use with cellular telephone communications, the antenna comprising:
a planar supporting substrate sized to be secured to a vertical surface of a building or structure, wherein the planar substrate is configured to be secured to the vertical surface without requiring mounting holes to be formed in the vertical surface;
a ground plane formed at a second surface of the planar substrate, wherein the ground plane is formed of a conductive material;
a first set of spaced apart antenna elements formed at a first surface of the planar substrate, wherein the first set of spaced apart antenna elements are formed of a conductive material and are sized to wirelessly exchange communications signals at a first selected frequency or range of frequencies established for cellular telephone communications; and,
multiple conductive signal paths each coupled at a first end to one of the spaced apart antenna elements, and configured to be coupled at a second end to receive signals for electronic beam steering of the antenna, for remote electronic tilting of the antenna, or for operating the antenna as a phased array.

6. The antenna of claim 5, further comprising:
a second set of spaced apart antenna elements formed at the first surface of the substrate, wherein the second set of spaced apart antenna elements are sized to wirelessly exchange communications signals at a second selected frequency or range of frequencies established for cellular telephone communications,
wherein the first frequency or range of frequencies are higher than the second frequency or range of frequencies.

7. The antenna of claim 5, further comprising:
an output port electronically coupled to the first set of antenna elements and to the ground plane; and,
an antenna controller electronically coupled to the output port, wherein the antenna controller is configured to electronically steer a beam of the first set of spaced apart antenna elements based on a received control signal.

8. The antenna of claim 5 wherein a front surface of the planar substrate is painted to camouflage the antenna with respect to a building or structure on which the antenna is mounted.

9. The antenna of claim 5 wherein the first set of antenna elements comprises an array of multiple independent, substantially square, conductive patch antennas.

10. The antenna of claim 5 wherein the antenna is configured for use within a building in a picocell or femtocell wireless communications system.

11. The antenna of claim 5, further comprising an antenna controller coupled to the antenna, wherein the antenna controller operates the first set of antenna elements as a phased array.

12. The antenna of claim 5, further comprising an antenna controller coupled to the antenna, wherein the antenna controller receives control signals under a luant interface standard to operate the first set of antenna elements under remote electrical tilt operation.

13. The antenna of claim 5 wherein the first set of antenna elements are sized and shaped for transmitting and/or receiving wireless signals at 1710 MHz to 1755 MHz, 2110 MHz to 2155 MHz, 1900 MHz, 850 MHz or 700 MHz.

14. The antenna of claim 5, further comprising an antenna output port at the second surface, wherein a conductor extending through the planar substrate connects at least one of the antenna elements to the antenna output port, and wherein the planar substrate is formed of a dielectric material.

15. The antenna of claim 5, further comprising an antenna output port at an edge of the planar substrate, wherein a conductor extending along the first surface of the planar substrate connects at least one of the antenna elements to the antenna output port, and wherein the planar substrate is formed of a dielectric material.

16. The antenna of claim 5, further comprising an antenna output port at an edge of the planar substrate, wherein a conductor extending within the planar substrate connects at least one of the antenna elements to the antenna output port, and wherein the planar substrate is formed of a dielectric material.

17. The antenna of claim 5, further comprising an antenna output port at an edge of the planar substrate, wherein a conductor connects at least one of the antenna elements to the antenna output port, and wherein the planar substrate is formed of two portions of dielectric material having the conductor sandwiched therebetween.

18. The antenna of claim 5, further comprising:
a conductive heating element secured at the second surface of the planar substrate, wherein the conductive heating element is configured to heat an adhesive when a current is applied to the conductive heating element to permit removal of the planar substrate from the building or structure.

19. An antenna for use with wireless mobile communications, the antenna comprising:
a supporting substrate sized to be secured to a vertical surface, wherein the supporting substrate is configured to be secured to the vertical surface without requiring mounting holes to be formed in the vertical surface;
an antenna ground plane formed at a second surface of the supporting substrate, wherein the ground plane is formed of a conductive material;
a first set of spaced apart, and independently operable antenna elements formed at a first surface of the supporting substrate, wherein the first set of spaced apart antenna elements are formed as conductive surfaces and are sized to wirelessly exchange communications signals at a first predetermined frequency or first predetermined range of frequencies for wireless mobile communications; and,
wherein the spaced apart antenna elements are configured for electronic beam steering of the antenna, for remote electronic tilting of the antenna, or for operating the antenna as a phased array.

20. The antenna of claim 19, further comprising:
a second set of spaced apart antenna elements formed at the first surface of the supporting substrate, wherein the second set of spaced apart antenna elements are sized to wirelessly exchange communications signals at a predetermined selected frequency or second predetermined range of frequencies established for wireless mobile communications,
wherein the first frequency or range of frequencies are higher than the second frequency or range of frequencies.

21. The antenna of claim 19, further comprising:
an output port electronically coupled to the first set of antenna elements and to the ground plane; and,
an antenna controller electronically coupled to the output port, wherein the antenna controller is configured to electronically steer a beam of the first set of spaced apart antenna elements based on a received control signal.

22. The antenna of claim 19, further comprising:
a conductive heating element secured at the second surface of the supporting substrate, wherein the conductive heating element is configured to heat an adhesive when a current is applied to the conductive heating element to permit removal of the supporting substrate from the vertical surface.
